(19) United States
(12) Patent Application Publication
(10) Pub. No.: US 2015/0192433 A1
(43) Pub. Date: Jul. 9, 2015

(54) MAGNETIC FIELD ROTATION DETECTION SENSOR AND MAGNETIC ENCODER

(71) Applicant: ALPS ELECTRIC CO., LTD., Tokyo (JP)

(72) Inventors: Takashi Onodera, Niigata-ken (JP); Hiroaki Endo, Niigata-ken (JP); Tokuo Nakamura, Niigata-ken (JP); Takafumi Noguchi, Niigata-ken (JP)

(21) Appl. No.: 14/560,453

(22) Filed: Dec. 4, 2014

(30) Foreign Application Priority Data
Jan. 8, 2014 (JP) 2014-001748

(51) Int. Cl. G01D 5/16

(52) U.S. Cl. CPC G01D 5/16

(57) ABSTRACT

A magnetic field rotation detection sensor that detects a rotation of a magnet, includes: a plurality of first magnetic sensor elements constituting a first bridge circuit; and a plurality of second magnetic sensor elements constituting a second bridge circuit, wherein sensitivity axes of the plurality of first magnetic sensor elements and sensitivity axes of the plurality of second magnetic sensor elements are oriented in directions where the sensitivity axes intersect each other, and the plurality of first magnetic sensor elements are disposed further inside than the plurality of second magnetic sensor elements.

### CLAIM OF PRIORITY

This application claims benefit of priority to Japanese Patent Application No. 2014-001748 filed on Jan. 8, 2014, which is hereby incorporated by reference in its entirety.

### BACKGROUND

1. Field of the Disclosure

The present disclosure relates to a magnetic field rotation detection sensor and a magnetic encoder, and particularly relates to a magnetic field rotation detection sensor and a magnetic encoder, which are capable of detecting the angle of a magnetic field generated from a rotating magnet.

2. Description of the Related Art

International Publication No. WO2010/098472 discloses an angle detection device for detecting the angle of a rotating magnet. FIG. 10A is a plan view illustrating a magnetic sensor which is used in an angle detection device of the related art disclosed in International Publication No. WO2010/098472, and FIG. 10B is a side view illustrating the angle detection device of the related art.

As shown in FIG. 10A, a magnetic sensor 120 is configured to include four magneto resistance element pairs 122a to 122d, and each of the four magneto resistance element pairs 122a to 122d is constituted by two magneto-resistive effect elements in which the magnetization directions of a fixed magnetic layer are oriented in the same direction. In the magnetic sensor 120, the magneto resistance element pair 122a and the magneto resistance element pair 122d are connected to each other to form a first bridge circuit. The magneto resistance element pairs 122b and the magneto resistance element pairs 122c are connected to each other to form a second bridge circuit. As shown in FIG. 10A, a virtual line that links the magneto resistance element pairs 122a and the magneto resistance element pairs 122d which constitute the bridge circuit and a virtual line that links the magneto resistance element pairs 122b and the magneto resistance element pairs 122c intersect each other at a sensor center 125. The magneto resistance element pairs 122a to 122d are disposed in a cross-multiplication shape.

As shown in FIG. 10B, the magnetic sensor 120 is disposed so as to be inclined by angle φ with respect to the rotation plane (XY plane) of a magnet 115. A magnetic field, which is generated from the magnet 115, intersects the magnetism sensitive surface of the magnetic sensor 120. Thus, the magnitude of an x component and the magnitude of a y component of the magnetic field acting on the magneto resistance element pairs 122a to 122d can be caused to be different from each other. Therefore, since the output of the magnetic sensor 120 comes close to a triangular wave shape, it is possible to improve the linearity of the output, and to detect the rotation angle of the magnet 115 with a high degree of accuracy.

In addition, Japanese Patent No. 4117175 discloses a magnetic field rotation detection device having a magnetic sensor disposed on the inner circumferential side of an annular magnet. According to the magnetic field rotation detection device disclosed in Japanese Patent No. 4117175, the magnetic sensor is disposed so as to cause the center between a plurality of magneto resistance elements constituting two bridge circuits and the center of the magnet to be coincident with each other, thereby allowing detection accuracy to be improved.

However, in an angle detection device 110 of the related art disclosed in International Publication No. WO2010/098472, it is difficult to dispose the magnetic sensor 120 so as to be inclined with respect to the rotation plane of the magnet 115, and thus a problem occurs in that there is a large restriction in application to a product in which a disposition method and a space are limited.

FIG. 11 is a graph illustrating a detection angle and a detection angle error of an angle detection device of the related art. FIG. 11 illustrates a case where an angle φ between the magnet 115 and the magnetic sensor element 120 shown in FIG. 10B is 0 degrees, that is, a case where the magnetic sensor 120 is disposed in parallel within the rotation plane of the magnet 115.

As shown in FIG. 11, a theoretical detection angle shows the same value as the rotation angle of the magnet 115 to form a straight line. However, an actual-measurement detection angle gives rise to an error with respect to a theoretical value. The angular displacement of the magnetic field itself, which is generated from the magnet 115, and the error component of the magnetic sensor 120 are included in the detection angle error.

In the angle detection device 110 of the related art, the displacement in the direction of a magnetic field, which is generated from the magnet 115, is generated in the in-plane of the magnetic sensor element 120. As shown in FIG. 10A, the magneto resistance element pairs 122a to 122d constituting two bridge circuits are disposed in a cross-multiplication shape, and, for example, the direction of the magnetic field acting on the magneto resistance element pair 122a and the magneto resistance element pair 122d and the direction of the magnetic field acting on the magneto resistance element pair 122b and the magneto resistance element pair 122c may be different from each other. In such a case, error components of outputs from two bridge circuits are not able to be cancelled, and thus a detection angle error caused by the variation of the magnetic field direction occurs. Consequently, as shown in FIG. 11, the magnitudes of the absolute values of the errors are different from each other when the rotation angle of the magnet is positive and when the rotation angle is negative, and thus a problem occurs in that the errors in the entire detection range of the rotation angle increase.

In addition, in the angle detection device of the related art disclosed in Japanese Patent No. 4117175, when a variation occurs in the direction of the magnetic field acting on each magneto resistance element, such as when the positional displacement of the magnetic sensor occurs and the sensor position is not coincident with the central position of the magnet, similarly to the graph shown in FIG. 11, the magnitudes of the errors are different from each other due to a difference in the rotation direction of the magnet, and thus a problem occurs in that the absolute values of the errors increase.

### SUMMARY

A magnetic field rotation detection sensor that detects a rotation of a magnet, includes: a plurality of first magnetic sensor elements constituting a first bridge circuit; and a plurality of second magnetic sensor elements constituting a second bridge circuit. The sensitivity axes of the plurality of first magnetic sensor elements and sensitivity axes of the plurality of second magnetic sensor elements are oriented in directions where the sensitivity axes intersect each other, and the plurality of first magnetic sensor elements are disposed further inside than the plurality of second magnetic sensor elements.

Accordingly, a plurality of first magnetic sensor elements are disposed further inside than a plurality of second magnetic sensor elements. Thus, even when the variation of the direction of the magnetic field acting on the magnetic field rotation detection sensor occurs, magnetic fields having an angle error act on both the plurality of first magnetic sensor elements which are disposed outside and the plurality of second magnetic sensor elements which are disposed inside. Consequently, the detection angle errors of the respective magnetic sensor elements, which arise from the variation of the magnetic field direction, are averaged by each of the first bridge circuit and the second bridge circuit. That is, the angle error of any one of the first bridge circuit and the second bridge circuit is prevented from increasing, and thus it is possible to reduce the angle error as a whole. Therefore, it is possible to suppress the error of the detection angle of the magnetic field rotation detection sensor.

In another aspect, a magnetic encoder includes: a magnet, which is rotatably provided, and a magnetic field rotation detection sensor, which is disposed facing the magnet. The the magnetic field rotation detection sensor includes a plurality of first magnetic sensor elements constituting a first bridge circuit and a plurality of second magnetic sensor elements constituting a second bridge circuit, sensitivity axes of the plurality of first magnetic sensor elements and sensitivity axes of the plurality of second magnetic sensor elements are oriented in directions where the sensitivity axes intersect each other, and the plurality of first magnetic sensor elements are disposed further inside than the plurality of second magnetic sensor elements.

Accordingly, a plurality of first magnetic sensor elements are disposed further inside than a plurality of second magnetic sensor elements. Thus, even when the variation of the direction of the magnetic field acting on the magnetic field rotation detection sensor occurs, magnetic fields having an angle error act on both the plurality of first magnetic sensor elements which are disposed outside and the plurality of second magnetic sensor elements which are disposed inside. Consequently, the detection angle errors of the respective magnetic sensor elements, which arise from the variation of the magnetic field direction, are averaged by each of the first bridge circuit and the second bridge circuit. That is, the angle error of any one of the first bridge circuit and the second bridge circuit is prevented from increasing, and thus it is possible to reduce the angle error as a whole. Therefore, it is possible to suppress the error of the detection angle of the magnetic field rotation detection sensor.

### BRIEF DESCRIPTION OF THE DRAWINGS

FIG. 1 is a plan view schematically illustrating a magnetic encoder according an embodiment of the present invention.

FIG. 2 is a plan view illustrating a magnetic field rotation detection sensor according to the present embodiment.

FIG. 3A is a circuit diagram illustrating a first bridge circuit according to the present embodiment, and FIG. 3B is a circuit diagram illustrating a second bridge circuit.

FIG. 4 is a schematic plan view illustrating actions of the magnetic field rotation detection sensor according to the present embodiment.

FIG. 5 is a graph schematically illustrating a detection angle and a detection angle error of the magnetic field rotation detection sensor according to the present embodiment.

FIG. 6 is a schematic plan view illustrating a magnetic encoder according to a first example.

FIGS. 7A to 7C are schematic plan views illustrating a magnetic encoder according to a second example.

FIG. 8 is a plan view illustrating a magnetic field rotation detection sensor according to first modified example of the present embodiment.

FIG. 9 is a plan view illustrating a magnetic field rotation detection sensor according to a second modified example of the present embodiment.

FIG. 10A is a plan view illustrating a magnetic sensor constituting an angle detection device of the related art, and FIG. 10B is a side view illustrating an angle detection device.

FIG. 11 is a graph illustrating a detection angle and a detection angle error of the angle detection device of the related art.

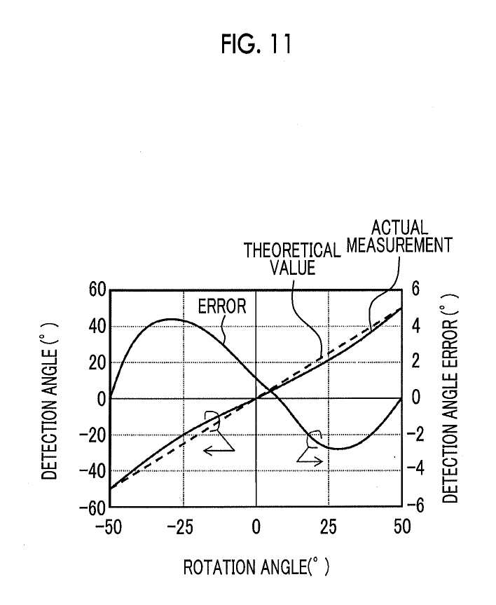

### DESCRIPTION OF THE EXEMPLARY EMBODIMENTS

Hereinafter, a magnetic encoder and a magnetic field rotation detection sensor according to an embodiment will be described with reference to the accompanying drawings. Meanwhile, dimensions in each of the drawings are shown by an appropriate change.

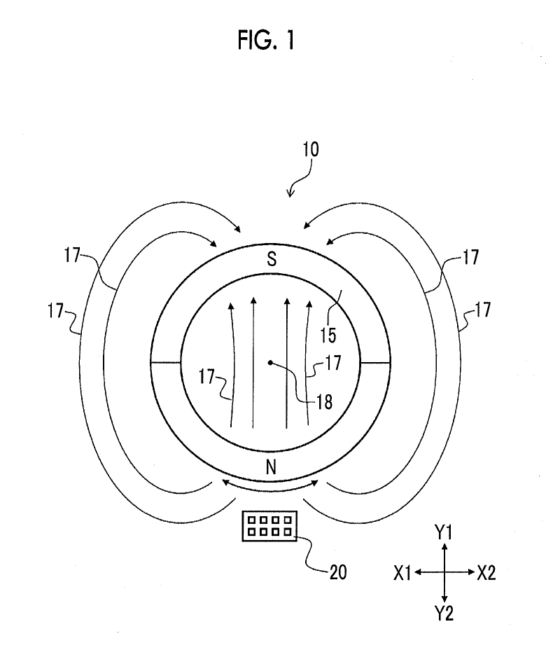

FIG. 1 is a plan view schematically illustrating a magnetic encoder according to an embodiment. As shown in FIG. 1, a magnetic encoder 10 according to the present embodiment is configured to include an annular magnet 15 and a magnetic field rotation detection sensor 20, which is disposed facing the magnet 15. The magnet 15 is provided rotatably about a central position 18 of the magnet 15. The magnet 15 is magnetized to two poles in a circumferential direction, and a magnetic field 17 is generated at outside and inside the magnet 15. The magnetic field rotation detection sensor 20 is disposed separately from the outer circumference of the magnet 15, and the direction of the magnetic field 17 acting on the magnetic field rotation detection sensor 20 changes with the rotation of the magnet 15. The rotation angle of the rotating magnet 15 can be detected by such a change in the direction of the LCD magnetic field 17.

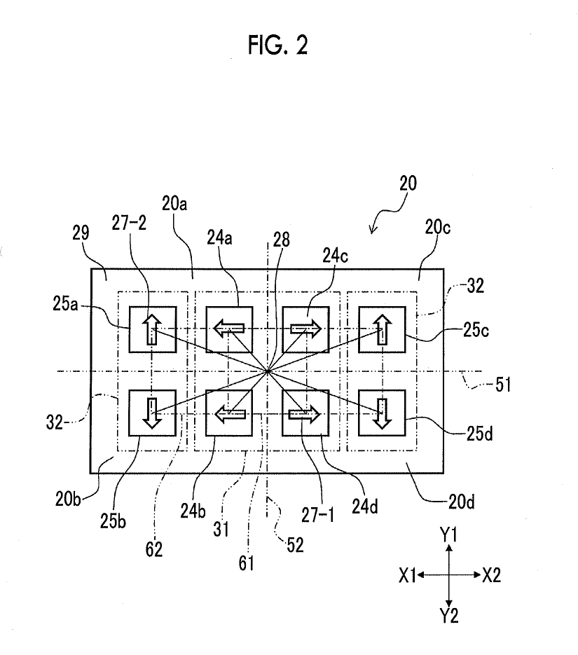

FIG. 2 is a plan view illustrating a magnetic field rotation detection sensor according to the present embodiment. As shown in FIG. 2, the magnetic field rotation detection sensor 20 according to the present embodiment is configured to include a plurality of first magnetic sensor elements 24a to 24d and a plurality of second magnetic sensor elements 25a to 25d, which are disposed in a substrate 29.

As shown in FIG. 2, sensitivity axes 27-1 of the plurality of first magnetic sensor elements 24a to 24d and sensitivity axes 27-2 of the plurality of second magnetic sensor elements 25a to 25d are oriented in directions where these axes intersect each other. The sensitivity axes 27 of the plurality of first magnetic sensor elements 24a to 24d are oriented in an X1 direction or an X2 direction, and the sensitivity axes 27 of the plurality of second magnetic sensor elements 25a to 25d are oriented in a Y1 direction or a Y2 direction. In the present embodiment, the plurality of first magnetic sensor elements 24a to 24d are connected to each other to form a first bridge circuit 31, and the plurality of second magnetic sensor elements 25a to 25d are connected to each other to constitute a second bridge circuit 32. As shown in FIG. 2, the plurality of first magnetic sensor elements 24a to 24d are disposed further inside than the plurality of second magnetic sensor elements 25a to 25d.

The wording “disposed inside” as used herein means that a rectangular region 61 which is constituted by the first magnetic sensor elements 24a to 24d are completely contained inside a rectangular region 62 which is constituted by the second magnetic sensor elements 25a to 25d.

In the present embodiment, GMR (Giant Magneto Resistance) elements are used as the first magnetic sensor elements 24a to 24d and the second magnetic sensor elements 25a to 25d. A magneto resistance film is used in the GMR element, and the magneto resistance film is formed of a laminated film including a fixed magnetic layer, a free magnetic layer, and the like. The magnetization direction of the fixed magnetic layer is fixed, and the magnetization direction of the fixed magnetic layer is the direction of the sensitivity axes 27-1 and the sensitivity axes 27-2 of each of the magnetic sensor elements 24a to 24d and 25a to 25d. In addition, the magnetization direction of the free magnetic layer changes depending on the direction of the magnetic field 17 of the magnet 15.

In the present embodiment, when the magnetic field 17 which is generated from the magnet 15 acts on the first magnetic sensor elements 24a to 24d and the second magnetic sensor elements 25a to 25d, and an angle between the magnetization direction of the fixed magnetic layer and the magnetization direction of the free magnetic layer changes, the resistance values of the first magnetic sensor elements 24a to 24d and the second magnetic sensor elements 25a to 25d changes. When the magnetization direction of the free magnetic layer changes so as to be parallel to the magnetization direction of the fixed magnetic layer, the resistance values decrease. Reversely, when the magnetization direction of the free magnetic layer changes so as to be antiparallel to the magnetization direction of the fixed magnetic layer, the resistance values increase.

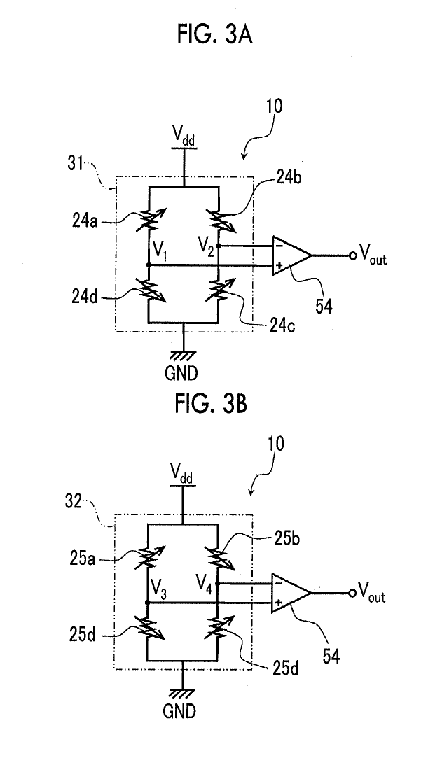

FIG. 3A is a circuit diagram illustrating a first bridge circuit according to the present embodiment, and FIG. 3B is a circuit diagram illustrating a second bridge circuit. As shown in FIG. 3A, the first magnetic sensor element 24a and the first magnetic sensor element 24d which are connected in series to each other and the first magnetic sensor element 24b and the first magnetic sensor element 24c which are connected in series to each other are connected in parallel to each other between a input terminal (V_{dd}) and a ground terminal (GND) to constitute the first bridge circuit 31. A middle-point voltage (V₁) is extracted from between the first magnetic sensor element 24a and the first magnetic sensor element 24d, which are connected in series to each other, and a middle-point voltage (V₂) is extracted from between the first magnetic sensor element 24b and the first magnetic sensor element 24c. A difference (V₁−V₂) between the middle-point voltage (V₁) and the middle-point voltage (V₂) is amplified by a differential amplifier 54 and is output as an output voltage (Vₒᵤₜ). In addition, as shown in FIG. 3B, the relationship of connection between the second magnetic sensor elements 25a to 25d is also similar to that in the first bridge circuit 31 to constitute the second bridge circuit 32.

As shown in FIG. 2, since the magnetic sensor elements (for example, the first magnetic sensor element 24a and the first magnetic sensor element 24d) which are connected in series to each other are configured such that the sensitivity axes 27 thereof are oriented in opposite directions to each other, the resistance values thereof when a magnetic field is applied change opposite to each other. Therefore, the middle-point voltages (V₁ and V₂) fluctuate, and a difference therebetween is amplified and is output as the output voltage (Vₒᵤₜ). In addition, since the sensitivity axes 27-1 of the first magnetic sensor elements 24a to 24d and the sensitivity axes 27-2 of the second magnetic sensor elements 25a to 25d are oriented in directions where the directions thereof intersect each other. Therefore, when the magnet 15 is rotated and the direction of the magnetic field 17 changes, an output from the first bridge circuit 31 and an output from the second bridge circuit 32 have a phase difference of 90 degrees.

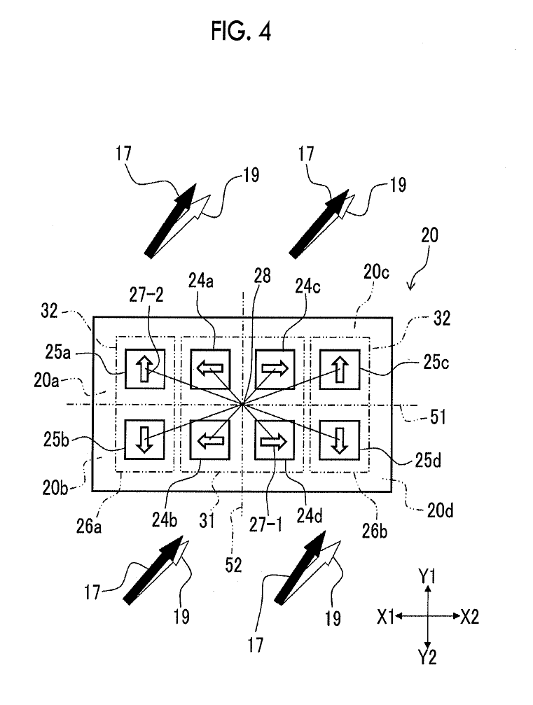

FIG. 4 is a schematic plan view illustrating actions of the magnetic field rotation detection sensor 20 according to the present embodiment. As shown in FIG. 4, the respective first magnetic sensor elements 24a to 24d are disposed so that a virtual line that links the first magnetic sensor element 24a to the first magnetic sensor element 24d and a virtual line that links the first magnetic sensor element 24b to the first magnetic sensor element 24c intersect each other. An intersection point between these virtual lines is set to a central position 28 of the sensor. The first magnetic sensor element 24a and the first magnetic sensor element 24d are disposed at positions which are in a rotational symmetry of 180 degrees with respect to the central position 28 of the sensor, and the first magnetic sensor element 24b and the first magnetic sensor element 24c are also similarly disposed in a rotational symmetry of 180 degrees.

Preferably, the intersection points between the virtual lines intersect each other at the central position of the respective virtual lines. Thus, a distance from the central position 28 to the first magnetic sensor element 24a is equal to a distance from the central position 28 to the first magnetic sensor element 24c. The same is true of the first magnetic sensor element 24b and the first magnetic sensor element 24d. Distances between the central position 28 and all the first magnetic sensor elements 24a to 24d may be equal to each other. This means that the centroids of the first magnetic sensor element 24a and the first magnetic sensor element 24d and the centroids of the first magnetic sensor element 24b and the first magnetic sensor element 24c are coincident with each other. Alternatively, all the centroids of the first magnetic sensor elements 24a to 24d are located at 28.

In addition, regarding the magnetic sensor elements 25a to 25d constituting the second bridge circuit 32, similarly, the respective second magnetic sensor elements 25a to 25d are disposed so that a virtual line that links the second magnetic sensor element 25a to the second magnetic sensor element 25d and a virtual line that links the second magnetic sensor element 25b and the second magnetic sensor element 25c intersect each other.

Preferably, distances between the central position 28 and the second magnetic sensor elements 25a and 25c are equal to each other, and distances between the central position and the second magnetic sensor elements 25b and 25d are also equal to each other. All the distances between the central position 28 and the second magnetic sensor elements 25a to 25d may be equal to each other. Thereby, the centroid of the first magnetic sensor elements 24a to 24d and the centroid of the second magnetic sensor elements 25a to 25d are coincident with each other. In addition, among the distances from the central position 28 to the respective elements, the distance therefrom to the first magnetic sensor element 24a is smaller than the distance therefrom to the second magnetic sensor element 25a. Magnitude relationships between the first magnetic sensor element 24b and the second magnetic sensor element 25b, the first magnetic sensor element 24c and the second magnetic sensor element 25c, and the first magnetic sensor element 24d and the second magnetic sensor element 25d are the same as each other.

As shown in FIG. 4, the intersection point between the virtual lines that link the second magnetic sensor elements 25a to 25d is coincident with the intersection point between the virtual lines that link the first magnetic sensor elements 24a to 24d. That is, the central position of the first magnetic sensor elements 24a to 24d and the central position of the second magnetic sensor elements 25a to 25d are disposed so as to be coincident with each other.

In this manner, the central position of the first magnetic sensor elements 24a to 24d constituting the first bridge circuit 31 and the central position of the first magnetic sensor elements 24a to 24d constituting the second bridge circuit 32 are caused to be coincident with each other, and thus it is possible to suppress a variation in the direction of a magnetic field acting on each sensor element, and to detect a magnetic field rotation angle with a high level of accuracy.

In FIG. 4, directions in which the magnetic field 17 generated from the magnet 15 (which is not shown in FIG. 4) acts on the magnetic field rotation detection sensor 20 are shown by arrows. It is preferable that the magnetic field 17 generated from the magnet 15 (which is not shown in FIG. 4) be uniformly distributed in the same direction within the magnetic field rotation detection sensor 20, and act on the first magnetic sensor elements 24a to 24d and the second magnetic sensor elements 25a to 25d at the same angle. However, in reality, a variation (non-uniformity) in the direction of the magnetic field 17 acting on the first magnetic sensor elements 24a to 24d and the second magnetic sensor elements 25a to 25d occurs with respect to an ideal magnetic field 19 in a direction corresponding to the rotation angle of the magnet 15. This is because a little difference occurs depending on the positions of the first magnetic sensor elements 24a to 24d and the second magnetic sensor elements 25a to 25d due to the direction of the magnetic field 17 being uneven and non-uniform.

Herein, as shown in FIG. 4, a virtual axis parallel to an X1-X2 direction through the central position 28 of each magnetic sensor element is set to a virtual X-axis 51, and a virtual axis parallel to a Y1-Y2 direction through the central position 28 of the magnetic sensor element is set to a virtual Y-axis 52. Four regions of the magnetic field rotation detection sensor 20 which are divided by the virtual X-axis 51 and the virtual Y-axis 52 are set to a first region 20a, a second region 20b, a third region 20c, and a fourth region 20d.

As shown in FIG. 4, the directions of the ideal magnetic field 19 generated from the magnet 15 face each other in the same direction at the respective regions 20a to 20d. On the other hand, the direction of the magnetic field 17 acting in reality has a large angle error with respect to the ideal magnetic field 19 at the first region 20a and the fourth region 20d, and has a small angle error with respect to the ideal magnetic field 19 at the second region 20b and the third region 20c. In this manner, a variation caused by the non-uniformity of the direction of the magnetic field 17 may occur in each of the regions 20a to 20d.

In the magnetic field rotation detection sensor 20 of the present embodiment, as shown in FIG. 4, the plurality of first magnetic sensor elements 24a to 24d are disposed inside the plurality of second magnetic sensor elements 25a to 25d. The plurality of second magnetic sensor elements 25a to 25d are configured to include a magnetic sensor element group 26a constituted by the second magnetic sensor elements 25a and 25b which are located on the X1 side and a magnetic sensor element group 26b constituted by the second magnetic sensor elements 25c and 25d which are located on the X2 side. The first magnetic sensor elements 24a to 24d are disposed so as to be interposed between the magnetic sensor element groups 26a and 26b in the X1-X2 direction.

As shown in FIG. 4, when a variation in the direction of the magnetic field 17 occurs by disposing the first magnetic sensor elements 24a to 24d and the second magnetic sensor elements 25a to 25d, magnetic fields having the same angle error act on both the plurality of first magnetic sensor elements 24a to 24d and the plurality of second magnetic sensor elements 25a to 25d. The detection angle errors of the first magnetic sensor elements 24a to 24d arising from a variation in the direction of the magnetic field are averaged by the first bridge circuit 31, and the detection angle errors of the second magnetic sensor elements 25a to 25d are averaged by the second bridge circuit 32. Thus, the error of any one of the first bridge circuit 31 or the second bridge circuit 32 is prevented from increasing, and thus the detection angle errors are averaged and output as a whole. Therefore, it is possible to suppress the error of the detection angle of the magnetic field rotation detection sensor 20.

In addition, it is preferable that the first magnetic sensor elements 24a to 24d and the second magnetic sensor elements 25a to 25d be respectively disposed in the four regions 20a to 20d which are divided by the virtual X-axis 51 and the virtual Y-axis 52. The first magnetic sensor element 24a and the second magnetic sensor element 25a are disposed in the region 20a, the first magnetic sensor element 24b and the second magnetic sensor element 25b are disposed in the region 20b, the first magnetic sensor element 24c and the second magnetic sensor element 25c are disposed in the region 20c, and the first magnetic sensor element 24d and the second magnetic sensor element 25d are disposed in the region 20d. According to this, error components of the detection angle caused by a variation in the direction of the magnetic field are averaged by the four regions 20a to 20d and are output from each of the first bridge circuit 31 and the second bridge circuit 32. In addition, in the four respective regions 20a to 20d, since magnetic fields act on the first magnetic sensor elements 24a to 24d and the second magnetic sensor elements 25a to 25d in the same direction, error components are averaged between an output of the first bridge circuit 31 and an output of the second bridge circuit 32. Therefore, it is possible to reliably reduce the detection angle error.

Meanwhile, the directions of the ideal magnetic field 19 and the magnetic field 17 shown in FIG. 4 are illustrative. Even when a variation in the direction of the magnetic field 17 is different, according to the present embodiment, the error components are averaged as described above, thereby allowing the detection angle error to be suppressed.

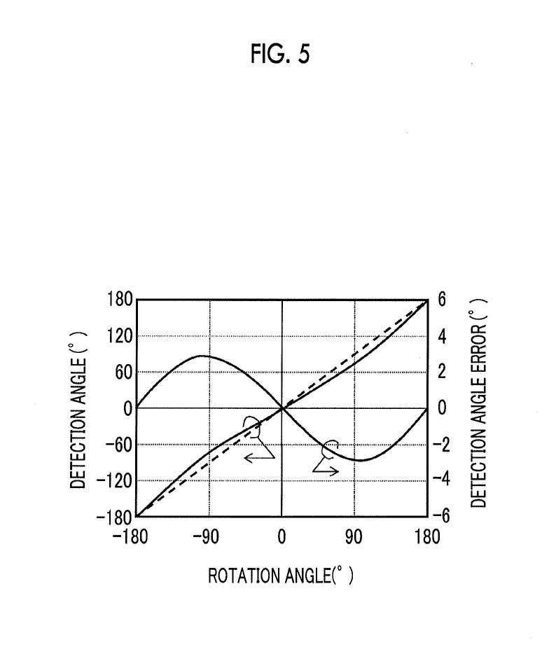

FIG. 5 is a graph schematically illustrating a detection angle and a detection angle error of the magnetic field rotation detection sensor 20 according to the present embodiment. As shown in FIG. 5, ideal detection angles when the magnet 15 is rotated 360 degrees (−180 degrees to 180 degrees) are shown by a dotted line, and actual detection angles are shown by a solid line. As shown in FIG. 4, due to a variation in the direction of the magnetic field of the magnet 15, the detection angle errors occur at the positive side at −180 degrees to 0 degrees, and the detection angle errors occur at the negative side at 0 degrees to 180 degrees. As described above, in the magnetic field rotation detection sensor 20 of the present embodiment, since the error components of the detection angle caused by a variation (non-uniformity) in the direction of the magnetic field are averaged and output, the absolute values of a detection error (for example, approximately 3 degrees) on the positive side and a detection error (for example, approximately −3 degrees) on the negative side have substantially the same magnitude with respect to the ideal detection angle. Therefore, it is possible to reduce the magnitude of the absolute value of the detection error when the magnet 15 is rotated once.

### First Example

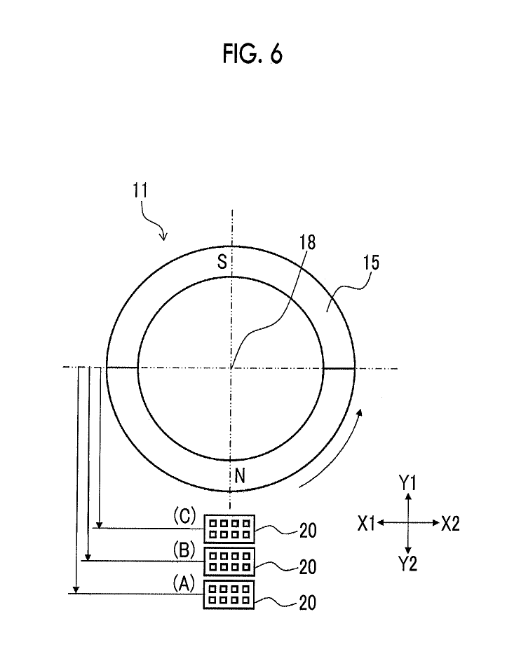

FIG. 6 is a schematic plan view illustrating a magnetic encoder according to a first example. As shown in FIG. 6, a magnetic encoder 11 according to the present example includes an annular magnet 15, and a magnetic field rotation detection sensor 20 which is disposed facing the outer circumference of the magnet 15, and the magnetic field rotation detection sensor 20 according to the present example has the same configuration as that of the magnetic field rotation detection sensor 20 shown in FIGS. 2 to 4 according to an embodiment. As shown in FIG. 6, when the position of the magnetic field rotation detection sensor 20 was made different in the radial direction of the magnet 15, detection angle errors occurring when the magnet 15 was rotated 360 degrees were evaluated.

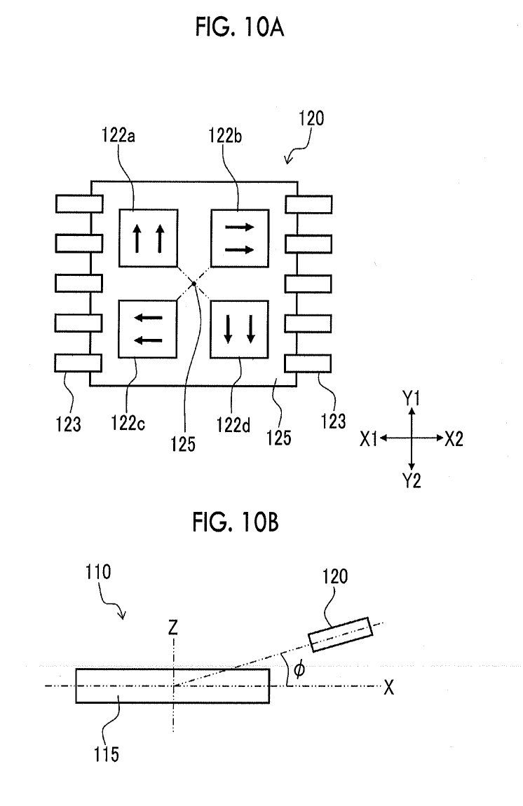

A distance between the magnetic field rotation detection sensor 20 located at a position (A) shown in FIG. 6 and the outer circumference of the magnet 15 is 3 mm, and a distance at a position (B) is 2.8 mm, and a distance at a position (C) is 2.6 mm. In addition, a magnetic encoder of a first comparative example is formed using a plurality of magnetic sensor element pairs having sensitivity axes in the same direction as shown in FIG. 10A as a comparative example, and using magnetic field rotation detection sensors disposed in a cross-multiplication shape so that the magnetic sensor element pairs intersect each other.

The following Table 1 shows detection angle errors when the magnet 15 is rotated 360 degrees with respect to the magnetic encoders of the first example and the first comparative example. Meanwhile, “Max” in the table show a maximum value of the detection angle error on the positive side with respect to the ideal detection angle, and “Min” shows a maximum value of the detection angle error on the negative side with respect to the ideal detection angle. A “absolute value” shows a maximum value (absolute value) within the absolute value of “Max” and the absolute value of “Min”, and is a maximum detection angle error occurring when the magnet 15 is rotated 360 degrees.

TABLE 1

| | | Arrangement of sensor with respect | | |
|---|---|---|---|---|
| | | to Magnet | | |
| Detection angle error | | A | B | C |
| First | Max | 1.7 | 5.8 | 19.2 |
| example | Min | −1.7 | −5.8 | −19.2 |
| | Absolute | 1.7 | 5.8 | 19.2 |
| | value | | | |
| First | Max | 1.4 | 5.7 | 18.6 |
| comparative | Min | −1.7 | −6.7 | −20.8 |
| example | Absolute | 1.7 | 6.7 | 20.8 |
| | value | | | |
| Angle | Max | 1.6 | 5.7 | 18.2 |
| displacement | Min | −1.6 | −5.7 | −18.2 |
| of magnetic | Absolute | 1.6 | 5.7 | 18.2 |
| field itself | value | | | |

As shown in Table 1, in both the first example and the first comparative example, there is a tendency for the detection angle error to increase as the arrangement of the magnetic field rotation detection sensor 20 comes closer to the magnet 15. In the first comparative example, for example, in the case of the position C, a difference between the absolute value of the maximum value (MAX) of the detection angle error and the absolute value of the minimum value (MIN) thereof occurs. On the other hand, in the magnetic field rotation detection sensor 20 of the first example, the absolute value of the maximum value (MAX) of the detection angle error and the absolute value of the minimum value (MIN) thereof show the same value. In addition, the absolute value of the detection angle error the first example shows a value smaller than that in the first comparative example.

In addition, as shown in the lower part of Table 1, the angle itself of a magnetic field, which is generated from the magnet 15, has displacement relative to the rotation angle of the magnet 15. That is, the detection angle error of the first example and the first comparative example shown in Table 1 is a value obtained by adding up the detection angle error of the magnetic field rotation detection sensor 20 and the angular displacement of the magnetic field which is generated from the magnet 15. The following Table 2 shows the detection angle error of the magnetic field rotation detection sensor 20 itself, except for the angular displacement of the magnetic field which is generated from the magnet 15.

TABLE 2

| | | Arrangement of sensor with respect | | |
|---|---|---|---|---|
| Difference with | | to Magnet | | |
| magnetic field angle | | A | B | C |
| First | Max | 0.1 | 0.1 | 1.1 |
| example | Min | −0.1 | −0.1 | −1.1 |
| | Absolute | 0.1 | 0.1 | 1.1 |
| | value | | | |
| First | Max | −0.1 | −0.1 | 0.4 |
| comparative | Min | −0.2 | −1.0 | −2.6 |
| example | Absolute | 0.2 | 1.0 | 2.6 |
| | value | | | |

As shown in Table 2, the detection angle error of the magnetic field rotation detection sensor 20 of the first example shows a value smaller than that in the first comparative example. In both the first example and the first comparative example, the detection angle error increases as the arrangement of the sensor comes closer to the magnet 15, but the absolute value of the error of the first example is 0.1 degrees with respect to the absolute value of 1.0 degrees of the error of the first comparative example in the position B, and the absolute value of the error of the first example is 1.1 degrees with respect to the absolute value of 2.6 degrees of the error of the first comparative example in the position C.

As stated above, the magnetic field rotation detection sensor 20 of the first example averages, the errors of the first magnetic sensor elements 24a to 24d and the second magnetic sensor elements 25a to 25d and outputs detection angles, thereby allowing the detection angle error to be suppressed.

In addition, as shown in Table 2, even when a distance between the magnetic field rotation detection sensor 20 and the magnet 15 changes, the magnetic field rotation detection sensor 20 of the first example can suppress an increase in error. Thus, when positional displacement occurs at the time of incorporating the magnetic field rotation detection sensor 20, or the like, it is possible to suppress the occurrence of the detection angle error.

### Second Example

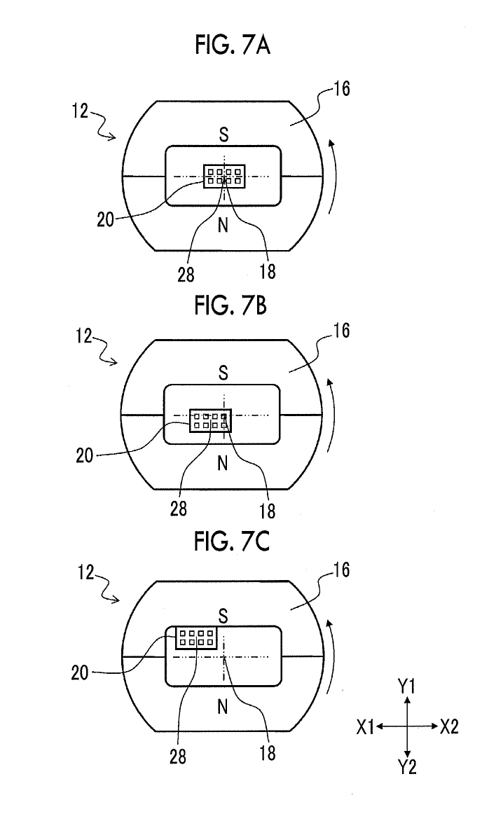

FIGS. 7A to 7C are schematic plan views illustrating a magnetic encoder of a second example. As shown in FIGS. 7A to 7C, a magnetic encoder 12 of the present example includes an annular magnet 16, and a magnetic field rotation detection sensor 20 which is disposed facing the inner circumference of the magnet 16, and the magnetic field rotation detection sensor 20 according to the present example has the same configuration as that of the magnetic field rotation detection sensor 20 shown in FIGS. 2 to 4 according to an embodiment. FIGS. 7A to 7C illustrate schematic plan views when the position of the magnetic field rotation detection sensor 20 is changed at the inside of the magnet 16. FIG. 7A illustrates a case where the central position 28 of the magnetic field rotation detection sensor 20 is disposed so as to overlap the central position 18 of the magnet 16, FIG. 7B illustrates a case where the central position 28 of the magnetic field rotation detection sensor 20 is disposed so as to be displaced from the central position 18 of the magnet 16, and FIG. 7C illustrates a case where the magnetic field rotation detection sensor 20 is disposed in the vicinity of the inner circumference of the magnet 16.

The Y direction dimension of the magnetic field rotation detection sensor 20 is 0.5 mm and the X direction dimension thereof is 0.6 mm, whereas in FIG. 7B, the central position 28 is displaced by 0.3 mm in the X1 and Y2 directions with respect to the magnet central position 18. In addition, in FIG. 7C, the central position is displaced by 0.5 mm in the X1 and Y1 directions.

In addition, as is the case with the first comparative example, a magnetic field rotation detection sensor is used which is disposed so that magnetic sensor element pairs intersect each other using a plurality of magnetic sensor element pairs having sensitivity axes in the same direction as shown in FIG. 10A as a second comparative example, and the magnetic encoder of the second comparative example is formed by disposing the sensor at positions shown in FIGS. 7A to 7C.

The following Table 3 and Table 4 show results of evaluating the detection angle error occurring when the magnet 16 is rotated 360 degrees with respect to FIGS. 7A to 7C. Table 3 shows values of the detection angle error inclusive of the angular displacement of a magnetic field, which is generated from the magnet 16, and Table 4 shows values of the detection angle error of the magnetic field rotation detection sensor 20 itself, except for the angular displacement of the magnetic field. A ring magnet central position arrangement A of Table 3 and Table 4 is an arrangement shown in FIG. 7A, an arrangement B is an arrangement shown in FIG. 7B, and an arrangement C is an arrangement shown in FIG. 7C.

TABLE 3

| | | Arrangement of sensor with respect | | |
|---|---|---|---|---|
| | | to Magnet | | |
| Detection angle error | | A | B | C |
| First | Max | 0.0 | 0.2 | 1.4 |
| example | Min | −0.1 | −0.1 | −1.8 |
| | Absolute | 0.1 | 0.2 | 1.8 |
| | value | | | |
| First | Max | 0.0 | 0.1 | 1.3 |
| comparative | Min | −0.1 | −0.2 | −1.9 |
| example | Absolute | 0.1 | 0.2 | 1.9 |
| | value | | | |
| Angle | Max | 0.0 | 0.1 | 1.3 |
| displacement | Min | 0.0 | −0.1 | −1.3 |
| of magnetic | Absolute | 0.0 | 0.1 | 1.3 |
| field itself | value | | | |

TABLE 4

| | | Arrangement of sensor with respect | | |
|---|---|---|---|---|
| Difference with | | to Magnet | | |
| magnetic field angle | | A | B | C |
| Second | Max | 0.0 | 0.1 | 0.1 |
| example | Min | 0.0 | 0.0 | −0.5 |
| | Absolute | 0.0 | 0.0 | 0.5 |
| | value | | | |
| Second | Max | 0.0 | 0.0 | 0.1 |
| comparative | Min | 0.0 | −0.1 | −0.6 |
| example | Absolute | 0.0 | 0.1 | 0.6 |
| | value | | | |

The distribution of a magnetic field located at the inside of the magnet 16 is uniform as compared to the outer circumferential side of the magnet 16. Thus, the variation of the direction of magnetic fields acting on each of the first magnetic sensor elements 24a to 24d and the second magnetic sensor elements 25a to 25d of the magnetic field rotation detection sensor 20 is small, and the value of the detection angle error is smaller than that in the first example. As shown in Table 3 and Table 4, in the arrangement A (FIG. 7A), errors hardly occur in both the second example and the second comparative example.

As shown in Table 4, in the arrangement B (FIG. 7B) and the arrangement C (FIG. 7C), the angle detection error occurs. As shown in Table 4, the absolute value of the detection angle error of the magnetic field rotation detection sensor 20 of the second example is set to a small value of 0.1 degrees with respect to the absolute value of the detection angle error of the second comparative example, and the detection angle error is also reduced in the present example.

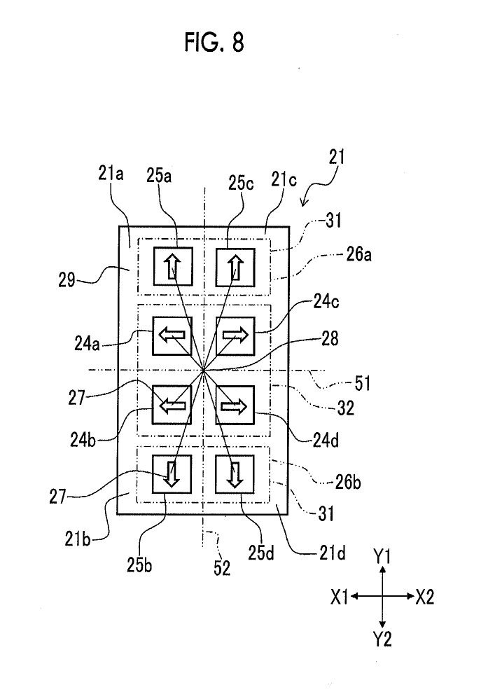

FIG. 8 is a plan view illustrating a magnetic field rotation detection sensor according to a first modified example of the present embodiment. A magnetic field rotation detection sensor 21 of the first modified example shown in FIG. 8 has different arrangements of the first magnetic sensor elements 24a to 24d and the second magnetic sensor elements 25a to 25d. In this modified example, one magnetic sensor element group 26a is constituted by the second magnetic sensor element 25a and the second magnetic sensor element 25c, and another magnetic sensor element group 26b is constituted by the second magnetic sensor element 25b and second magnetic sensor element 25d. A plurality of first magnetic sensor elements 24a to 24d are disposed so as to be interposed between two magnetic sensor element groups 26a and 26b in the Y1-Y2 direction. That is, the plurality of first magnetic sensor elements 24a to 24d are interposed between the second magnetic sensor elements 25a to 25d in the radial direction of the magnet 15.

In such an aspect, similarly to the magnetic field rotation detection sensor 21, the first magnetic sensor elements 24a to 24d are disposed further inside than the second magnetic sensor elements 25a to 25d. In addition, the first magnetic sensor elements 24a to 24d and the second magnetic sensor elements 25a to 25d are disposed in each of regions 21a to 21d which are divided by the virtual X-axis 51 and the virtual Y-axis 52. Thereby, when the variation of the direction of the magnetic field 17 which is generated from the magnet 15 occurs, the detection angle errors are averaged and output by the first magnetic sensor elements 24a to 24d and the second magnetic sensor elements 25a to 25d, and thus the detection angle errors can be reduced.

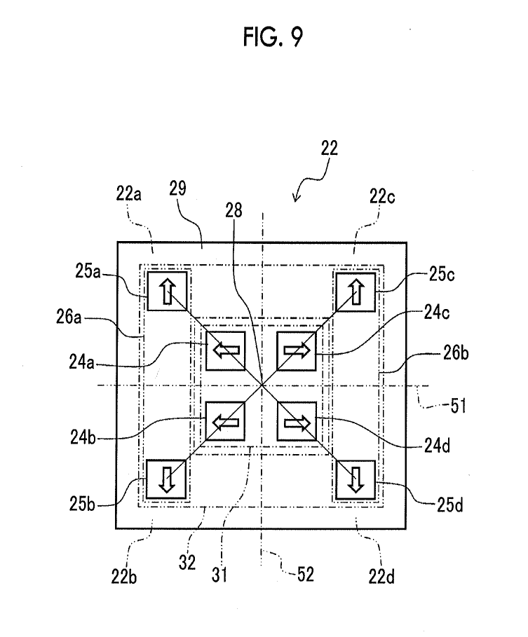

FIG. 9 is a plan view of a magnetic field rotation detection sensor according to a second modified example of the present embodiment. As shown in FIG. 9, in a magnetic field rotation detection sensor 22 of the second modified example, the first magnetic sensor element 24a and the first magnetic sensor element 24d are disposed in a rotational symmetry of 180 degrees with respect to the sensor central position 28. The second magnetic sensor element 25a and the second magnetic sensor element 25d are provided on an extended line of a virtual line that links the first magnetic sensor element 24a to the first magnetic sensor element 24d. Similarly, the first magnetic sensor element 24b and the first magnetic sensor element 24c are disposed in a rotational symmetry of 180 degrees with respect to the central position 28. The second magnetic sensor element 25b and the second magnetic sensor element 25c are provided on an extended line of a virtual line that links the first magnetic sensor element 24b to the first magnetic sensor element 24c.

In this modified example, the first magnetic sensor elements 24a to 24d are also disposed further inside than the second magnetic sensor elements 25a to 25d. In addition, a plurality of second magnetic sensor elements 25a to 25d are configured to include the magnetic sensor element group 26a which is constituted by the second magnetic sensor elements 25a and 25b located on the X1 side and the magnetic sensor element group 26b which is constituted by the second magnetic sensor elements 25c and 25d located on the X2 side. The first magnetic sensor elements 24a to 24d are disposed so as to be interposed between the magnetic sensor element groups 26a and 26b in the X1-X2 direction.

In such an arrangement, when the variation of the direction of the magnetic field 17 which is generated from the magnet 15 occurs, the detection angle errors are averaged and output by the first magnetic sensor elements 24a to 24d and the second magnetic sensor elements 25a to 25d, and thus the detection angle errors can be reduced.

It should be understood by those skilled in the art that various modifications, combinations, sub-combinations and alterations may occur depending on design requirements and other factors insofar as they are within the scope of the appended claims of the equivalents thereof.

What is claimed is:

1. A magnetic field rotation detection sensor that detects a rotation of a magnet, comprising:
a plurality of first magnetic sensor elements constituting a first bridge circuit; and
a plurality of second magnetic sensor elements constituting a second bridge circuit,
wherein sensitivity axes of the plurality of first magnetic sensor elements and sensitivity axes of the plurality of second magnetic sensor elements are oriented in directions where the sensitivity axes intersect each other, and
the plurality of first magnetic sensor elements are disposed further inside than the plurality of second magnetic sensor elements.

2. The magnetic field rotation detection sensor according to claim 1, wherein the plurality of second magnetic sensor elements include two magnetic sensor element groups which are disposed separately from each other, and the plurality of first magnetic sensor elements are disposed so as to be interposed between the two magnetic sensor element groups.

3. The magnetic field rotation detection sensor according to claim 1, wherein when virtual axes intersecting each other at a center of the plurality of first magnetic sensor elements are set to a virtual X-axis and a virtual Y-axis, the virtual X-axis is parallel to the sensitivity axes of the first magnetic sensor elements, and the virtual Y-axis is parallel to the sensitivity axes of the second magnetic sensor elements, and
the first magnetic sensor elements and the second magnetic sensor elements are respectively disposed in four regions which are divided by the virtual X-axis and the virtual Y-axis.

4. The magnetic field rotation detection sensor according to claim 3, wherein centroids of the plurality of first magnetic sensor elements and centroids of the plurality of second magnetic sensor elements are coincident with each other.

5. The magnetic field rotation sensor according to claim 1, wherein the magnet is annular, and the plurality of first magnetic sensor elements and the plurality of second magnetic sensor elements are disposed facing an outer circumference of the magnet.

6. The magnetic field rotation sensor according to claim 1, wherein the magnet is annular, and the plurality of first magnetic sensor elements and the plurality of second magnetic sensor elements are disposed facing an inner circumference of the magnet.

7. A magnetic encoder comprising:
a magnet which is rotatably disposed; and
a magnetic field rotation detection sensor, which is disposed facing the magnet,
wherein the magnetic field rotation detection sensor includes a plurality of first magnetic sensor elements constituting a first bridge circuit and a plurality of second magnetic sensor elements constituting a second bridge circuit,
sensitivity axes of the plurality of first magnetic sensor elements and sensitivity axes of the plurality of second magnetic sensor elements are oriented in directions where the sensitivity axes intersect each other, and
the plurality of first magnetic sensor elements are disposed further inside than the plurality of second magnetic sensor elements.

8. The magnetic encoder according to claim 7, wherein the plurality of second magnetic sensor elements include two magnetic sensor element groups which are disposed separately from each other, and the plurality of first magnetic sensor elements are disposed so as to be interposed between the two magnetic sensor element groups.

9. The magnetic encoder according to claim 7, wherein when virtual axis lines intersecting each other at a center of the plurality of second magnetic sensor elements are set to a virtual X-axis and a virtual Y-axis, the virtual X-axis is parallel to the sensitivity axes of the first magnetic sensor elements, and the virtual Y-axis is parallel to the sensitivity axes of the second magnetic sensor elements, and
the first magnetic sensor elements and the second magnetic sensor elements are respectively disposed in four regions which are divided by the virtual X-axis and the virtual Y-axis.

10. The magnetic encoder according to claim 7, wherein the magnet is annular, and the magnetic field rotation detection sensor is disposed facing an outer circumference of the magnet.

11. The magnetic encoder according to claim 7, wherein the magnet is annular, and the magnetic field rotation detection sensor is disposed facing an inner circumference of the magnet.
